(19) United States
(12) Patent Application Publication
(10) Pub. No.: US 2008/0269667 A1
(43) Pub. Date: Oct. 30, 2008

(54) Handpiece for Ultrasonic Electro-Medical Apparatuses

(75) Inventor: Giuseppe Gencarelli, Milano (IT)

Correspondence Address: WILLIAM J. SAPONE;COLEMAN SUDOL SAPONE P.C., 714 COLORADO AVENUE, BRIDGE PORT, CT, 06605, US

(73) Assignee: ITALIA MEDICA S.P.A., Milano (IT)

(21) Appl. No.: 11/816,919

(22) PCT Filed: Feb. 21, 2006
(86) PCT No.: PCT/IB2006/000352

§ 371 Date: Aug. 23, 2007

(30) Foreign Application Priority Data
Feb. 24, 2005 (IT) BO2005A 000097

(51) Int. Cl. A61H 1/00

(52) U.S. Cl. 604/22

(57) ABSTRACT

The proposed handpiece (1) for ultrasonic electro-medical apparatuses includes a grip (2), which carries a support shaft (3) designed for coupling removably with a operating tip (4) by fastening means including a first truncated-cone protrusion (6), connected to the support shaft (3) and engaging with a corresponding first truncated cone seat (60) connected to the operating tip (4), to define at least one conical coupling between the operating tip (4) and the support shaft (3).

### BACKGROUND OF THE INVENTION

The present invention relates to the technical field concerning ultrasonic electro-medical apparatuses, with particular reference to a handpiece for such apparatuses.

### BRIEF DESCRIPTION OF PRIOR ART

In the field of ultrasonic electro-medical apparatuses, e.g. for maxillo-facial applications and/or for treatment of dermal ulcers, handpieces are known, which are substantially formed by a grip, designed for taking hold by the operator, which ends with a shaft, having an operating tip connected thereto removably, for treatment on a patient in a prefixed operation area.

The handpiece is connected to an electronic pulse generator, provided with adjustment means, which generates electric pulses sent to the ultrasonic transducer by a flexible cable, including also at least one flexible hose for adduction of a sterile liquid, to ensure the patient's operation area being wet.

The sterile liquid passes through one or more ducts made in the grip and corresponding ducts made in the operating tip, so as to flow, at a selected pressure, to the patient's operation area.

With particular reference to FIG. 2, concerning a handpiece of the prior art, the operating tip 98 is removably coupled with the support shaft 91 by threaded fastening means, usually including a threaded shank 92, aimed at engaging, when coupled, with a relative threaded seat 93, until the terminal section of the operating tip 98 and the one of the support shaft 91 go in abutment against each other.

The above kind of fastening means is scarcely reliable and functional, because the threaded portions, outer and/or inner, can be damaged after a limited number of coupling/decoupling actions, which results in putting at risk the operating tip and/or the support shaft, consequently the handpiece, for subsequent uses.

Moreover, a remarkable, not less important problem derives from extremely probable fatigue breakage of the threaded portions, completely responsible for mechanical resistance to the handpiece torsion during use thereof.

It is to be pointed out that such breakage usually occurs when the stress is stronger, that is during the intervention on the patient, which puts at risk his/her safety.

Moreover, the fastening means can be barely firm and reliable during the intervention on the patient, due to the ultrasonic mechanical stresses, to which the support shaft is subjected, that can lead to the uncoupling of the latter from the operating tip.

### SUMMARY OF THE INVENTION

The object of the present invention is to avoid the above mentioned drawbacks by proposing a handpiece for ultrasonic electro-medical apparatuses, particularly indicated for maxillo-facial applications and/or for treatment of dermal ulcers, which allows high reliability and functionality standards during performance of any operation.

A further object of the present invention is to propose a handpiece, which can ensure an extremely firm and reliable coupling between the operating tip and the support shaft, characterized by a high mechanical resistance to torsion and fatigue.

Another object of the present invention is to propose an extremely strong and versatile handpiece, which allows particularly simple and rapid maintenance operations.

The above mentioned objects are obtained in accordance with the contents of claims.

The above mentioned objects are obtained in accordance with the contents of claims, by the handpiece for ultrasonic electro-medical apparatuses of the type including a grip provided with a support shaft designed to couple removably, by fastening means, with a operating tip for operating on a patient's prefixed area; with said grip having electric connections for electric supply of an ultrasonic transducer cooperating with the support shaft, and hydraulic connections for addiction of a sterile liquid to be sprayed on the patient's operation area; characterized in that said fastening means include at least one protrusion, substantially shaped as a truncated-cone, designed to engage with a relevant seat, substantially shaped as a truncated cone, to define at least one first conical coupling between said operating tip and said support shaft.

### BRIEF DESCRIPTION OF THE DRAWINGS

The characteristic features of the invention will be pointed out in the following description of some preferred, but not exclusive embodiments, with reference to the enclosed figures, in which:

FIG. 1 is a schematic, lateral view of the proposed handpiece, with the relative support shaft coupled with a operating tip;

FIG. 2 is an enlarged, partial axial section view of a prior art handpiece, at a position corresponding to the coupling section between the support shaft and a operating tip;

FIGS. 3, 4 are schematic, enlarged, partial axial section views of the proposed handpiece, in the coupling section between the support shaft and a operating tip, according to two different embodiments.

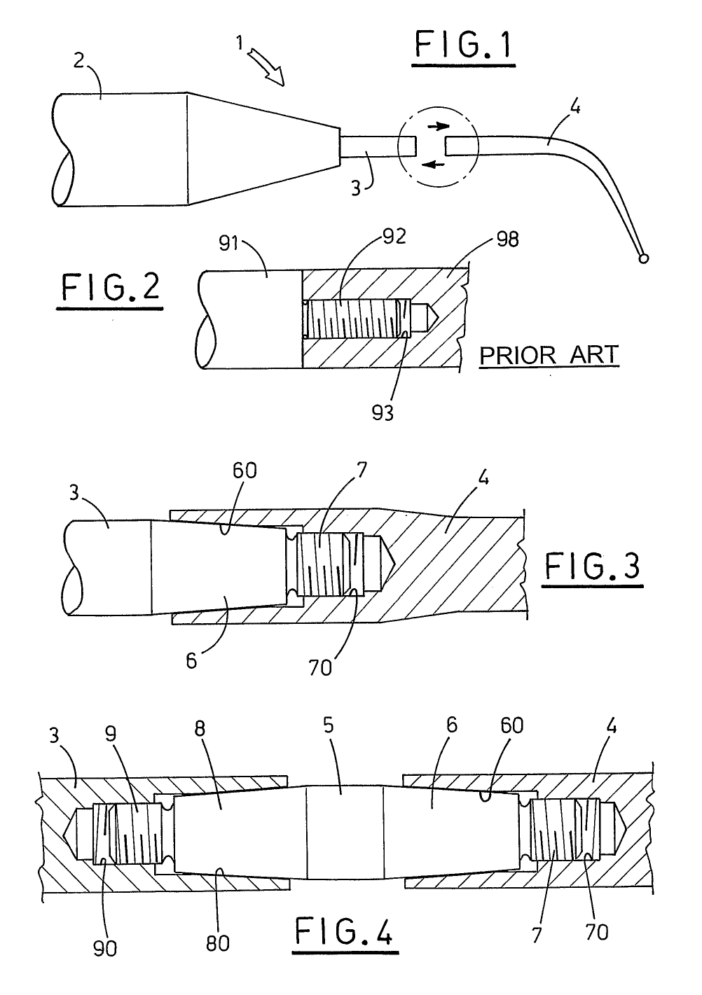

### DESCRIPTION OF THE PREFERRED EMBODIMENTS OF THE INVENTION

With reference to the above described Figures, the general reference 1 specifies the proposed handpiece for ultrasonic electro-medical apparatuses, particularly indicated for maxillo-facial applications and for treatment of dermal ulcers, which includes a grip 2, having a support shaft 3 designed for coupling removably, by fastening means, with a operating tip 4, that works on a patient, in a prefixed operation area.

In known way, the grip 2 has electric and hydraulic connections, respectively for electric supply of an ultrasonic transducer (not shown), cooperating with the support shaft 3, and for adducing a sterile liquid to be sprayed to the operation area.

In an innovative way, according to a first embodiment, the fastening means include a first truncated-cone protrusion 6, connected to the support shaft 3, and aimed at engaging with a relative first truncated cone seat 60, connected to one end of the operating tip 4, to define a first conical coupling, e.g. an interference fit (FIG. 3).

Advantageously, the fastening means include also a first threaded shank 7, connected to the first truncated-cone protrusion 6 and aimed at engaging with a corresponding first threaded seat 70, fastened to the first truncated cone seat 60, so as to define a first screw coupling, which stabilizes the first conical coupling.

In a wholly analogous way, according to another embodiment (not shown), the first truncated-cone protrusion 6 and the relative first threaded shank 7 can be connected to the operating tip 4; whereas the first truncated cone seat 60 and the relative threaded seat 70 can be connected to the support shaft 3.

With reference to a second embodiment, the handpiece 1 fastening means include a connecting piece 5, which can couple removably with the operating tip 4, at one of its ends, and with the support shaft 3, at the other end (FIG. 4).

The fastening means include also a second truncated-cone protrusion 8, aimed at engaging with a second truncated cone seat 80, connected to the support shaft 3, to define a second conical coupling between the connecting piece 5 and the support shaft 3; while the first conical coupling is defined by the connection of the connecting piece 5 with the operating tip 4.

Consequently, the truncated-cone protrusions, first 6 and second 8, are connected to the end of the connecting piece 5, and the truncated cone seats, first 60 and second 80, are connected to the end of the operating tip 4 and of the support shaft 3.

The two conical couplings, first and second, can form e.g. an interference fit.

Advantageously, the fastening means include also a second threaded shaft 9, connected to the second truncated-cone protrusion 8 and aimed at engaging with a relative second threaded seat 90, connected to the second truncated cone seat 80, to define a second screw coupling, which stabilizes the second conical coupling.

In a wholly analogous way, according to further embodiments (not shown), at least one of the truncated-cone protrusions (6, 8) can be connected to one end of the connecting piece 5, while at least one of the truncated-cone seats (60, 80) can be connected to the end of the support shaft 3, or to the operating tip 4.

In the same way, according to further embodiments (not shown), at least one of the truncated-cone seats (60, 80) can be connected to one end of the connecting piece 5, while at least one of the truncated-cone protrusions (6, 8) can be connected to the end of the support shaft 3, or to the operating tip 4.

In particular, the truncated-cone protrusions (6, 8) can be connected to the ends of the support shaft 3 and of the operating tip 4, while the truncated cone seats (60, 80) can be connected to the ends of the connecting piece 5.

According to still further embodiments, including or not the connecting piece 5, the coupling between the connecting piece 5 and the operating tip 4 can be ensured also only by the conical coupling, first and/or second, without using the screw coupling, first and/or second, for stabilizing thereof.

It is clearly understood from the above description how the proposed handpiece for ultrasonic electro-medical apparatuses, particularly indicated for maxillo-facial applications and/or for treatment of dermal ulcers, allows high reliability and functionality standards to be obtained in any operation condition, avoiding any accidental and/or undesired disengaging of the operating tip from the corresponding support shaft.

The double coupling, conical and threaded, between the terminal section of the operating tip and the support shaft, allows to avoid any accidental and/or undesired disengaging, caused by ultrasonic vibrations.

This allows the stability and reliability of the coupling between the operating tip and the support shaft to be optimized.

In particular, the screw coupling stabilizes the conical coupling, which supports practically all the mechanical torsional and fatigue stresses, to which the operating tip and the support shaft are subjected when they are coupled.

This allows a high structural strength and an excellent mechanical reliability to be obtained for the coupling between the operating tip and the support shaft.

In particular, the connecting piece ensures the integrity of the operating tip, as well as of the support shaft, thus of the handpiece, because in case of breaking, it is the weak point of the coupling

1. Handpiece for ultrasonic electro-medical apparatuses of the type including a grip (2) provided with a support shaft (3) designed to couple removably, by fastening means, with an operating tip (4) for operating on a patient's prefixed area; with said grip (2) having electric connections for electric supply of an ultrasonic transducer cooperating with the support shaft (3), and hydraulic connections for addition of a sterile liquid to be sprayed on the patient's operation area; characterized in that said fastening means include at least one protrusion (6), substantially shaped as a truncated-cone, designed to engage with a relevant seat (60), substantially shaped as a truncated cone, to define at least one first conical coupling between said operating tip (4) and said support shaft (3).

2. Handpiece, as claimed in claim 1, characterized in that said first conical coupling forms an interference fit.

3. Handpiece, as claimed in claim 1, characterized in that said first protrusion (6) is connected to one end of the support shaft (3), and the first seat (60) is connected to one end of the operating tip (4).

4. Handpiece, as claimed in claim 1, characterized in that said first protrusion (6) is connected to one end of the operating tip (4), and the first seat (60) is connected to one end of the support shaft (3).

5. Handpiece, as claimed in claim 1, characterized in that said fastening means include at least one first threaded shaft (7), which engages with a corresponding first threaded seat (70) to define a first screw coupling for stabilizing said first conical coupling, defined by said first protrusion (6) and said first seat (60).

6. Handpiece, as claimed in claim 5, characterized in that said first threaded seat (70) is connected to the first seat (60) and the relative threaded shank (7) is connected to the first protrusion (6).

7. Handpiece, as claimed in claim 1, characterized in that said fastening means include at least one connecting piece (5), whose one end couples removably with the operating tip (4) and whose other end couples with the support shaft (3), to define at least said first conical coupling.

8. Handpiece, as claimed in claim 7, characterized in that said fastening means include a second protrusion (8), substantially shaped as a truncated-cone, which engages with a corresponding second seat (80), substantially shaped as a truncated-cone, to define a second conical coupling between the connecting piece (5) and the operating tip (4), or the support shaft (3).

9. Handpiece, as claimed in claim 8, characterized in that said second conical coupling forms an interference fit.

10. Handpiece, as claimed in claim 8, characterized in that at least one of said protrusions, first (6) or second (8), is connected to one end of the connecting piece (5); and in that at least one said seats, first (60) or second (80), is connected to the end of the support shaft (3), or to the operating tip (4).

11. Handpiece, as claimed in claim 10, characterized in that said protrusions, first (6) and second (8), are connected to the ends of the connecting piece (5), and the relative seats (60, 80) are connected to the ends of the support shaft (3) and of the operating tip (4).

12. Handpiece, as claimed in claim 8, or 9, or 10, characterized in that at least one of said seats, first (60) or second (80), is connected to an end of the connecting piece (5); and in that at least one of said protrusions, first (6) or second (8), is connected to the end of the support shaft (3) or of the operating tip (4).

13. Handpiece, as claimed in claim 12, characterized in that said protrusions, first (6) and second (8), are connected to the ends of the support shaft (3) and of the operating tip (4), and the relative seats (60, 80) are connected to the ends of the connecting piece (5).

14. Handpiece, as claimed in claim 8, characterized in that said fastening means include at least one first threaded shank (7), which engages with a corresponding first threaded seat (70), to define at least one first screw coupling to stabilize said first conical coupling.

15. Handpiece, as claimed in claim 14, characterized in that said first threaded seat (70) is connected to the first seat (60) and the relative threaded shank (7) is connected to the first protrusion (6).

16. Handpiece, as claimed in claim 14, characterized in that said fastening means include a second threaded shank (9), which engages with a corresponding second threaded seat (90), to define at lest one second screw coupling, which stabilizes said second conical coupling.

17. Handpiece, as claimed in claim 16, characterized in that said second threaded seat (90) is connected to the second seat (80) and the relative threaded shank (9) is connected to the second protrusion (8).

18. Use of the handpiece for ultrasonic apparatuses as claimed in claim 1 for treatment of dermal ulcers.

19. Use of the handpiece for ultrasonic apparatuses as claimed in claim 1 for maxillofacial applications.

20. Handpiece, as claimed in claim 2, characterized in that said first protrusion (6) is connected to one end of the support shaft (3), and the first seat (60) is connected to one end of the operating tip (4).

21. Handpiece, as claimed in claim 2, characterized in that said first protrusion (6) is connected to one end of the operating tip (4), and the first seat (60) is connected to one end of the support shaft (3).

22. Handpiece, as claimed in claim 9, characterized in that at least one of said protrusions, first (6) or second (8), is connected to one end of the connecting piece (5); and in that at least one said seats, first (60) or second (80), is connected to the end of the support shaft (3), or to the operating tip (4).

23. Handpiece, as claimed in claim 9, characterized in that at least one of said seats, first (60) or second (80), is connected to an end of the connecting piece (5); and in that at least one of said protrusions, first (6) or second (8), is connected to the end of the support shaft (3) or of the operating tip (4).

24. Handpiece, as claimed in claim 10, characterized in that at least one of said seats, first (60) or second (80), is connected to an end of the connecting piece (5); and in that at least one of said protrusions, first (6) or second (8), is connected to the end of the support shaft (3) or of the operating tip (4).

25. Handpiece, as claimed in claim 15, characterized in that said fastening means include a second threaded shank (9), which engages with a corresponding second threaded seat (90), to define at lest one second screw coupling, which stabilizes said second conical coupling.
